(19) United States
(12) Patent Application Publication
(10) Pub. No.: US 2021/0161762 A1
(43) Pub. Date: Jun. 3, 2021

(54) OBJECT-ORIENTED WEIGHT ACUPRESSURE CUSHION

(71) Applicant: Jeung Bong GO, Seoul (KR)

(72) Inventors: Jeung Bong GO, Seoul (KR); Sun Rim LEE, Jeju-si (KR); Suh Yun GO, Jeju-si (KR); Min Jeong GO, Jeju-si (KR)

(21) Appl. No.: 17/259,520

(22) PCT Filed: Jul. 12, 2019
(86) PCT No.: PCT/KR2019/008644

§ 371 Date: Jan. 11, 2021

(30) Foreign Application Priority Data
Jul. 12, 2018 (KR) 10-2018-0081148
May 20, 2019 (KR) 10-2019-0059083

(51) Int. Cl. A61H 39/04

(52) U.S. Cl. CPC A61H 39/04; A61H 2201/169; A61H 2201/0134

(57) ABSTRACT

The present invention is an object-oriented weight acupressure cushion enabling a user to freely administer acupressure while self-altering the human body part receiving acupressure, and enabling acupressure to not be administered on a human body part which does not require acupressure. The object-oriented weight acupressure cushion, according to the present invention, comprises: an outer cover part; a cushion part received in the inner space of the outer cover part and providing a cushioning feeling to a human body part; a pocket part received in the inner space of the cushion part; and a weight body received in the inner space of the pocket part and enabling acupressure to be administered to the human body part.

### TECHNICAL FIELD

The present invention relates to an object-oriented weight acupressure cushion. and more particularly, to an object-oriented weight acupressure cushion allowing a user to freely administer acupressure while self-altering the human body part receiving acupressure.

### BACKGROUND ART

In general, meridian points consist of about 365 points in the meridian system where the disease response is sensitive.

The manual therapy for correcting the modulation of the living body, improving the health or curing the diseases by compressing such meridian points with the thumb or palm is called acupressure.

Many automatic acupressure devices have been developed and used because a lot of power is exhausted when a person manually performs the acupressure.

However, since there is no conventional automatic acupressure device developed ergonomically, acupressure may be applied to unnecessary parts of the body, causing pain to the user, and the area for acupressure is limited.

In addition, since the body part cannot be moved when acupressure is performed by using the conventional automatic acupressure device, it is necessary to stop the operation of the conventional automatic acupressure device and perform acupressure to other body parts when acupressure is applied to other body parts, so acupressure may not be smoothly performed.

As related documents belonging to the technical field of the present invention, there are Korean Unexamined Patent Publication No. 10-2012-0029184, etc.

### DETAILED DESCRIPTION OF THE INVENTION

### Technical Problem

The present invention has been suggested to solve the problems of the related art, and an object of the present invention is to provide an object-oriented weight acupressure cushion allowing a user to freely administer acupressure while self-altering the human body part receiving acupressure and preventing acupressure from being applied to unnecessary parts of the body.

### Technical Solution

The object-oriented weight acupressure cushion according to the present invention includes an outer cover part; a cushion part received in an inner space of the outer cover part to provide a cushioning feeling to a human body part; a pocket part received in an inner space of the cushion part; and a weight member received in an inner space of the pocket part to enable acupressure to be administered to the human body part.

The weight member may have a weight that applies pressure in a range of 0.1 mmHg to 200 mmHg.

In addition, the cushion part may have a Young's modulus in a range of 0.001 Kpa to 1000 Kpa.

Further, the weight member may include at least one selected from stone, wood, metal, plastic, and non-metal.

In addition, the object-oriented weight acupressure cushion may further include a coupling part formed on an outer surface of the pocket part and protruding to an outside by passing through the cushion part and the outer cover part.

### Advantageous Effects of the Invention

According to the object--oriented weight acupressure cushion of the present invention, a weight member for acupressure, which is formed of a heavy and hard material is filled inside the pocket part for object orientation, shapes of the pocket part and the cushion part are elastically deformed in match with the body part due to the weight of the weight member, so the user can effectively perform acupressure by self-moving the area to be subject to acupressure in a state in which the acupressure device makes contact with the body part, and it is possible to perform acupressure evenly on a wide body part and strongly on a local body part, thereby improving acupressure efficiency. In addition, since the user is allowed to freely perform acupressure while self-altering the human body part receiving acupressure, it is possible to prevent unnecessary pain and prevent acupressure from being applied to unnecessary body parts.

### DESCRIPTION OF THE DRAWINGS

FIG. 1 is a perspective view showing an object-oriented weight acupressure cushion according to the present invention.

FIG. 2 is a sectional view showing an object-oriented weight acupressure cushion according to the present invention.

FIG. 3 is a perspective view showing a state of use of an object-oriented weight acupressure cushion according to the present invention.

### MODE FOR INVENTION

Advantages and features of the present invention, and a method of achieving them will become apparent with reference to embodiments described below in detail in association with the accompanying drawings.

However, the present invention is not limited to the embodiments disclosed below, but may be implemented in a variety of different forms, and these embodiments are intended only to complete the disclosure of the present invention, and to fully inform the scope of the invention to those skilled in the art to which the present invention pertains, and the present invention is only defined by the scope of the claims. The same reference numerals refer to the same components throughout the specification.

Hereinafter, embodiments of the present invention will be described in detail with reference to the accompanying drawings so that those skilled in the art may easily implement the present invention. However, the present invention may be implemented in various different forms, and is not limited to the embodiments described herein. The same reference numerals are assigned to similar parts throughout the specification.

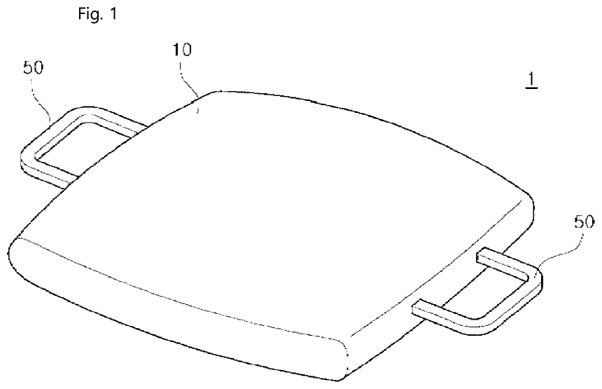

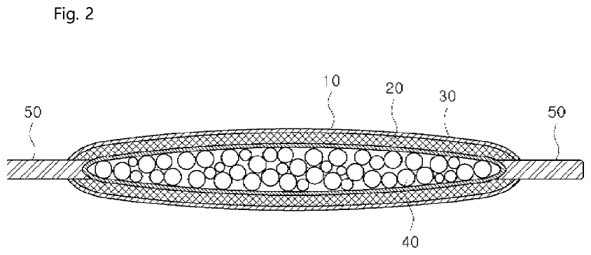

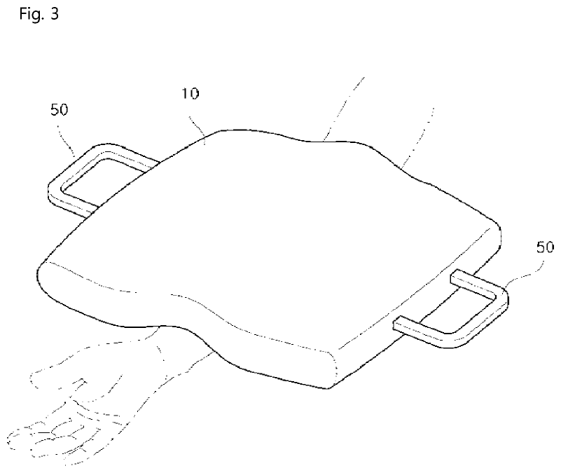

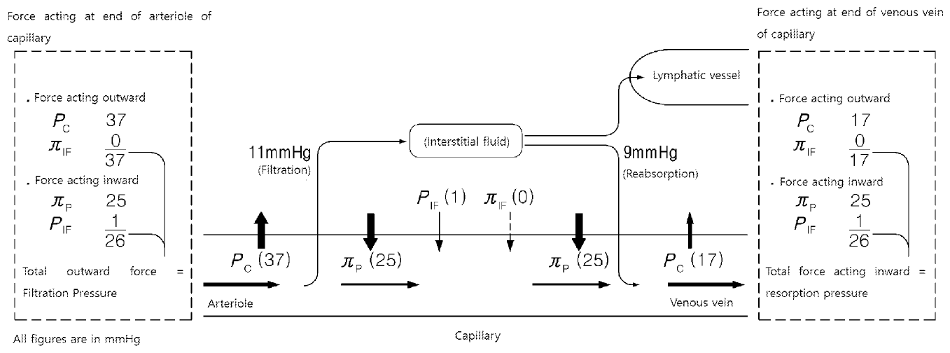

FIG. 1 is a perspective view showing an object-oriented weight acupressure cushion according to the present invention, FIG. 2 is a sectional view showing the object-oriented weight acupressure cushion according to the present invention, and FIG. 3 is a perspective view showing a state of use of the object-oriented weight acupressure cushion according to the present invention.

The present invention provides object-oriented weight acupressure cushion, in which the user can perform acupressure on a desired body part such as hands, arms, and legs, while self-altering the body part to be subject to acupressure, and pain or unnecessary acupressure that may occur during acupressure can be prevented so that optimal acupressure can be achieved.

To this end, the object--oriented weight acupressure cushion 1 according to the present invention may include an outer cover part 10, a cushion part 20, a pocket part 30, and a weight member 40.

The outer cover part 10 may have one open side and may be formed therein with an empty space to accommodate the pocket part 30, the cushion part 20, and the like, which will be described below.

In this case, the open part of the outer cover part 10 may be opened and closed through an opening/closing device such as a zipper, a button, and a Velcro tape.

Since the outer cover part 10 directly make contact with the body of the user, the outer cover part 10may be formed of a soft material.

In other words, as the outer cover part 10 is formed of a soft material, strong friction, which may occur when the body part is moved to find the acupressure point in a state in which the heavy weight member 40 is applied for object orientation, can be prevented, thereby protecting the skin of the user.

In addition, a protecting part (not shown) formed of a waterproof material may be installed on an inner surface of the outer cover part 10 to protect the pocket part 30, the cushion part 20, the weight member 40, etc.

The cushion part 20 provides a feeling of cushion when the user uses the object-oriented weight acupressure cushion 1 according to the present invention, and is accommodated in the inner space of the outer cover part 10.

The cushion part 20 providing the feeling of cushion has an elastic modulus, which is expressed as a Young's modulus since it only needs a cushion against pressure in the longitudinal direction from the top to the bottom.

In this case, the cushion part 20 may be formed to have a tensile strength corresponding to the weight member 40 described above.

Although it may vary depending on the type or weight of the weight member 40, preferably, the cushion part 20 has the Young's modulus of 1000 Kpa or less in which the minimum Young's modulus is 0.001 Kpa or more.

That is, since the cushion part 20 directly makes contact with the sensitive body part and skin, the cushion part 20 needs to provide a soft feeling without pain, so the minimum Young's modulus is set to 0.001 Kpa, which is 1/10 or more of the pressure corresponding to 0.1 mmHg of the weight member.

In addition, when the cushion part 20 has an excessive Young's modulus of 1000 Kpa or more, the pain is increased because acupressure is applied only to a part of a curved skin, so it is preferable to set the Young's modulus not to exceed 1000 Kpa.

The cushion part 20 may be formed of a material such as foam resin, sponge, rubber, silicone, etc. so as to provide the feeling of cushion to the user, so that pain and damage can be reduced when the user performs acupressure on the body part.

Moreover, since the cushion part 20 is elastically deformed by the load of the user, when acupressure is applied to a curved body part such as an elbow or heel, the outer cover part 10 naturally adheres to the curved body part, thereby improving the acupressure effect.

The pocket part 30 is accommodated in the inner space of the outer cover part 10 in a state in which an outer surface of the pocket part 30 is wrapped by the cushion part 20.

The pocket part 30 has one open side and is formed therein with an empty space, so that the weight member 40 may be accommodated in the pocket part 30.

In this case, the open side of the pocket part 30 may be opened and closed through an opening/closing device such as a zipper, a button, and a Velcro tape so that various types of the weight member 40 can be replaced.

In addition, a plurality of partition walls may be formed in the pocket part 30 at regular intervals for preventing the weight member 40 from being biased to one side.

The weight member 40 is accommodated in the inner space of the pocket part 30 such that acupressure can be applied to the body part, and may include at least one selected from stone, wood, metal, plastic, and non-metal.

The weight member 40 may have a weight capable of applying a pressure in the range of 0.1 mmHg to 200 mmHg, and a plurality of weight members may be provided to increase the weight in order to realize the excellent acupressure effect.

In this case, since the weight member 40 that applies the pressure less than 0.1 mmHg lowers the acupressure effect and affects the user's blood pressure, it is preferred for the weight member 40 to apply the pressure less than 200 mg, which is the maximum value of blood pressure.

For example, the weight member 40 may have the weight in the range of about 20 kg to 30 kg.

Hereinafter, the description will be made with respect to the weight applied to the body parts.

In a state in which the cushion part 20 or the pocket part 30 having a vertical length of 70 cm is placed on the thigh, when the thigh and the outer cover part 10 are in contact with each other by only 10 cm, 760 mmHg=1 kgf/cm², 20 mmHg=1/38 kgf/cm²=0.0263 kgf/cm², and the contact area between the thigh and the cushion part 20 or the pocket part 30 is 10 cm×70 cm=700 cm². Therefore, the cushion weight giving the pressure of 20 mmHg is 0.0263×700=18.41 kg.

In addition, since the weight member 40 is applied to the body part, the weight member 40 may be formed of a material that is harmless to the human body and eco-friendly with a greater weight, in addition to the above-described materials.

In this case, the pocket part 30 needs not to be easily torn by the heavy weight member 40, and needs to be manufactured by a material having flexibility and elasticity such that the pocket part 30 can be elastically deformed together with the cushion part 20by the load of the user.

Meanwhile, the object-oriented weight acupressure cushion 1 according to the present invention may further include a coupling part 50 for stably coupling the outer cover part 10 and the pocket part 30.

The coupling part 50 may be formed of a material such as a string or a band, and may be formed in the shape of a handle having an approximately′ C′-shape cross-section.

The coupling part 50 may be sewn to both sides of the pocket part 30.

A portion of the coupling part 50 protrudes to an outside by passing through the cushion part 20 and the outer cover part 10.

The protruding portion of the coupling part 50 may serve as a kind of handle so that the user can easily carry the object-oriented weight acupressure cushion according to the present invention.

In addition, as the coupling part 50 integrally binds the cushion part 20, the pocket part 30, and the outer cover part 10, the cushion part 20 or the pocket part 30 can be prevented from moving or scattering inside the outer cover part 10 during the transportation process or the process of performing acupressure of the object-oriented weight acupressure cushion according to the present invention.

As described above, in the object--oriented weight acupressure cushion 1 according to the present invention, the weight member 40 formed of a heavy and hard material is filled in the pocket part 30for object orientation, and the the cushion part 20 and the pocket part 30 are elastically deformed by the load of the weight member 40, so that it is possible to apply acupressure by covering the desired body part as shown in FIG. 3.

In particular, it is possible to efficiently perform acupressure by self-moving the area to be subject to acupressure in a state in which the body part is in contact with the outer cover part 10, and it is possible to perform acupressure evenly in a wide area and strongly in a local area.

Next, the operation of the present invention will be described with reference to FIG. 4.

Pif=interstitial fluid hydrostatic pressure of 1 mmHg, which is almost constant, and Πf=interstitial fluid osmotic pressure of 0 mmHg, which is neglected. In addition, Πp=plasma colloidal osmotic pressure of 25 mmHg, which is constant.

When Pc =capillary arterial pressure is 37mmHg and venous pressure is 17 mmHg, the pressure to exit the vessel from the capillary artery side is 37-(25+1)=11 mmHg, the pressure to enter the vessel from the capillary vein side is (25+1)-17=9 mmHg, and difference of 2 mmHg enters the lymphatic vessel.

When arterial or venous pressure increases, or when interstitial fluid increases due to osmotic pressure changes, interstitial fluid pressure changes, etc., fluid retention or edema occurs in tissues.

When the tissue pressure is increased, interstitial fluid enters the capillary vein or the lymphatic vessel.

In the case of 11 mmHg or more, the entry from the artery is blocked so the process progresses more rapidly, but the blood supply to the tissue is stopped, resulting in ischemia.

If the skin layer is pressurized by about 20 mmHg, the pressure applied to the interstitial fluid due to the elasticity of the tissue may drop to half or less. If the edema is about 5 mmHg, it can be seen that even with a pressure of 5 mmHg or more, the interstitial fluid escapes to the lymphatic vessel or capillary veins as above.

Although it may vary depending on persons, a person may feel cool very slightly at 10 mmHgaccording to the body parts, feel cooler at 20 mmHg without ischemia symptom, and feel cool more and more as the pressure is increased, and the ischemic symptom appears strongly at about 30 mmHg.

Those skilled in the art to which the present invention pertains will appreciate that the present invention can be implemented in other specific forms without changing the technical spirit or essential features of the present invention. Therefore, it should be understood that the embodiments described above are illustrative and non-limiting in all respects. The scope of the present invention is represented by the appended claims rather than the detailed description, and all changes or modifications derived from the spirit and scope of the claims and the concept of equivalents thereof are included in the scope of the present invention.

[Description of reference numerals]

| | |
|---|---|
| 1: object-oriented weight cushion | 10: outer cover part |
| 20: cushion part | 30: pocket part |
| 40: weight member | 50: coupling part |

1. An object-oriented weight acupressure cushion comprising:
an outer cover part;
a cushion part received in an inner space of the outer cover part to provide a cushioning feeling to a human body part;
a pocket part received in an inner space of the cushion part; and
a weight member received in an inner space of the pocket part to enable acupressure to be administered to the human body part, wherein the weight member has a weight that applies pressure in a range of 0.1 mmHg to 200 mmHg.

2. The object-oriented weight acupressure cushion of claim 1, wherein the cushion part has a Young's modulus in a range of 0.001 Kpa to 1000 Kpa.

3. The object-oriented weight acupressure cushion of claim 1, wherein the weight member includes at least one selected from stone, wood, metal, plastic, and non-metal.

4. The object-oriented weight acupressure cushion of claim 3, further comprising a coupling part formed on an outer surface of the pocket part and protruding to an outside by passing through the cushion part and the outer cover part.
